(19) United States
(12) Patent Application Publication
(10) Pub. No.: US 2011/0238602 A1
(43) Pub. Date: Sep. 29, 2011

(54) METHOD FOR ENHANCED MARKETING OF VIBRATION MEDICINE PRODUCTS AND COACHING THEREFROM

(76) Inventor: Ilan Ovadia AZOURI, Tel Aviv (IL)

(21) Appl. No.: 13/154,444

(22) Filed: Jun. 7, 2011

Related U.S. Application Data
(63) Continuation-in-part of application No. 12/269,902, filed on Nov. 13, 2008.
(60) Provisional application No. 61/352,423, filed on Jun. 8, 2010.

(51) Int. Cl. G06Q 90/00

(52) U.S. Cl. 705/500

(57) ABSTRACT

It is provided a method for making and marketing vibration medicine products, which includes getting a vibration medicine product, packing the vibration medicine product into packed doses, attaching them to servings of a first product to get units of a second product, providing means for delivering guidance regarding an holistic significance of using the second product, and marketing the second product as being an improvement of the first product, being associated with the vibration medicine product, and using the second product being associated to the holistic significance. The method may include a step of changing the physical shape of the vibration medicine product to a different physical shape before packing into the plurality of packed doses, a liquid to powder, for example. Exemplary means for the delivering of guidance are by a written guiding label for affixing to a unit of the second product, or by a label having an integrated barcode for initiating a visit in a website presenting the guidance. The method may also include the steps of clients purchasing the second product, and following the guidance. Thus, the clients are being coached for self empowerment and spiritual evolvement.

### CROSS-REFERENCE TO RELATED APPLICATIONS

This application claims the benefits of U.S. provisional patent application Ser. No. 61/352,423 entitled “METHOD FOR ENHANCED MARKETING OF VIBRATION MEDICINE PRODUCTS AND COACHING THEREFROM” filed Jun. 8, 2010 by the present inventor. The current application is a Continuation in Part of U.S. patent application Ser. No. 12/269,902 entitled “METHOD FOR MARKETING VIBRATION MEDICINE PRODUCTS” filed Nov. 13, 2008 by the present inventor.

### BACKGROUND OF THE INVENTION

1. Field of the Invention

The invention is in the field of marketing products of alternative or complementary medicine. In particular, the invention deals with new methods to market vibration medicine products to the mass market.

2. Description of Related Art

Vibration Medicine (hereafter VM) is considered by its practitioners to be associated with “energy”, “frequency” and “vibrations” rather than the chemical and biological content of conventional medicines that work on the bio-physical dysfunctions. Vibration medicine is mainly used in complementary medicine and holistic fields such as homeopathy, vibration based devices (Hado) as developed by Massaru Emoto of Japan, B-com and Quaxi devices, etc. The term “vibration medicine” as used herein refers mainly to natural vibration medicine that uses natural elements like flower extractions and flower essences as in Bach flowers.

Bach Flower Remedies (also known as flower essences) have been developed since 1936 by Eduard Bach and followers, who have attributed the remedies unique balancing effect on user well being. Currently, there are over hundred brands worldwide, which offer natural sources for their vibration products using flowers, animals, human cells, sea essences, natural sacred places and phenomena like “vibrations” of moon light or a storm.

Vibration Medicine can be used as a balancing support to many people in dealing with a vast variety of physical and psychological situations, symptoms and imbalances (e.g., stress), as well as supporting personal development. Moreover, VM is considered absolutely safe with no restrictions whatsoever.

Most of the VM medicines are delivered in water-alcohol solutions (approximately 25%), wherein water is used as a carrier and alcohol is used as a preservatives. Flower essences are distributed mainly by practitioners and natural health shops and pharmacies in small glass bottles (typically 30 ml bottles) and in droppers with which the customer instill drops into his mouth. In homeopathy, the most recognized VM field, the common application method is by small pellets or globules which melt in consumer mouth.

The principles of VM are hard to capture and rather “intangible”. Therefore, VM is presently a relatively small market with low consumption and usage. Development of new Flower Remedy products led to a small increase of the market, but yet there is no access to the mass market. It seems that a bottleneck exists at the consumer side, preventing large scale market distribution, a bottleneck due to limited awareness and understanding of VM products. Thus, the mass market access necessitates special delivery and communication approach and new distribution channels.

One objective of the present invention is to bring natural Vibration Medicine to the mass market, and thus to increase worldwide vibration medicine consumption, and provide commercial success to active companies.

The inventor laid down the challenge to create and deliver new daily basic products—Vibration or “flower Essence”—products, that can support better balance, personal development and increased conscious awareness. The inventor asserts that should people in global mass market have friendly and easy access for using these products, they may maintain better balance and awareness, and it may help in creating a positive effect on future of humankind.

### BRIEF DESCRIPTION OF THE DISCLOSURE

It is provided according to some embodiments of the current invention, a method for making and marketing vibration medicine products. The method includes getting a vibration medicine product which include an essence, packing the vibration medicine product into packed doses, attaching the packed doses to servings of a first product to get units of a second product for sale, providing means for delivering guidance regarding an holistic significance of using the second product, and marketing the second product as including certain features. The features are being an improvement of the first product, being associated with the vibration medicine product, and using the second product being associated to the holistic significance. An end user purchases a second product unit, blends a packed dose into the attached serving and consumes it.

In some embodiments, the method further includes a step of changing the physical shape of the vibration medicine product to a different physical shape before packing into the plurality of packed doses. Preferably, the first physical shape is a liquid and the different physical shape is a powder. That change may be achieved by several processes. A first example is by spraying several drops of the vibration medicine product on sucrose globules while mixing, allowing the mixture to dry and grinding the globules into a powder of a desired particle size. A second example is by spraying several drops of the vibration medicine product on sugar crystals while mixing, allowing the mixture to dry, testing for dissolution, and if solubilty is poor, keeping on grinding up to getting particles at a desired size. A third example is spraying several drops of the vibration medicine product on icing sugar, while mixing, and allowing the mixture to dry. The vibration medicine may be blended with a flavouring hyrosol before the step of spraying.

Exemplary means for the delivering of guidance are by a written guiding label for affixing to a unit of the second product, by a label having an integrated barcode for initiating a visit in a website presenting the guidance, and by a website address label directing to a website presenting the guidance.

In some embodiments, the guidance is for spiritual or emotional or physical significance associated with use of the second product. Alternatively, the guidance is for intentions and actions to be taken before, during, or after the use of the second product. The intentions and actions are directed for self empowerment and spiritual evolvement of a user of the second product.

In some embodiments, the method includes the steps of clients purchasing the second product, and following the guidance. Thus, the clients are being coached for self empowerment and spiritual evolvement.

In some embodiments, the vibration medicine product includes water and alcohol at 20% to 85% alcohol rating. Exemplary vibration medicine products are Bach flowers remedies, Australian Bush flowers, Alaskan Flower essences and Pacific essences.

In some embodiments, the packed doses are dosing caps of drink bottles.

In some embodiments, the vibration medicine product is a brand vibration medicine product and the second product is licensed to be associated with the same brand vibration medicine.

In some embodiments, the first product is a bottled water unit, a soft drink, a chewing gum, a shampoo, a soap. or a personal care product.

It is provided according to some embodiments of the current invention, a method to enhance marketing of products of family of products. The products are of several kinds respectively associated with several spiritual and emotional states. The method includes receiving a vocal signal associated with a consumer, analyzing the vocal signal, associating certain spiritual and emotional state with the vocal signal in accordance with results of the analyzing, and suggesting the consumer to purchase a product of a kind associated to the certain spiritual and emotional state.

Exemplary family of products include food-and-beverage products, personal care products, personal development products, holistic products, and vibration medicine products.

In some embodiments, the method enhances marketing of bottled water units associated with several kinds of vibration medicine.

In some embodiments, the method is executed in a shop site equipped with a voice analyzing module adapted for analyzing intonation of a vocal signal and associating a source of the vocal signal with spiritual and emotional state.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof; may best be understood by reference to the following detailed description when read with the accompanied drawings in which:

FIG. 1 illustrates making and marketing of vibration medicine products.

FIG. 2 illustrates making and marketing of vibration medicine products including change of physical shape.

FIG. 3 is a flow chart of a method for making and marketing vibration medicine products.

FIG. 4a shows a first typical guiding label for affixing on a second product.

FIG. 4b shows a second typical guiding label for affixing on a second product.

FIG. 4c shows a third typical guiding label for affixing on a second product.

FIG. 4d shows a fourth typical guiding label for affixing on a second product.

FIG. 4e shows a fifth typical guiding label for affixing on a second product.

FIG. 4f shows a guiding label for affixing on a second product to emphasize actions and intentions associated with consuming the second product.

FIG. 5 Illustrates a method for enhancing marketing of food and beverage products.

FIG. 6 is a flow chart of a method for enhancing marketing of food and beverage products.

### DETAILED DESCRIPTION OF THE INVENTION

The present invention will now be described in terms of specific example embodiments. It is to be understood that the invention is not limited to the example embodiments disclosed. It should also be understood that not every feature of the methods for marketing VM products is necessary to implement the invention as claimed in any particular one of the appended claims. It should also be understood that throughout this disclosure, where a method is shown or described, the steps of the method may be performed in any order or simultaneously, unless it is clear from the context that one step depends on another being performed first.

Before explaining at least one embodiment of the invention in detail, it is to be understood that the invention is not limited in its application to the details set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The materials, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

The term holistic may refer to all aspects of being, body, mind and spirit, or physical aspects, emotional aspects, mental aspects, and spiritual aspects. As all these aspects are naturally intimately interconnected, it might relate directly to only one of them, and it is believed that the other aspects may be affected indirectly.

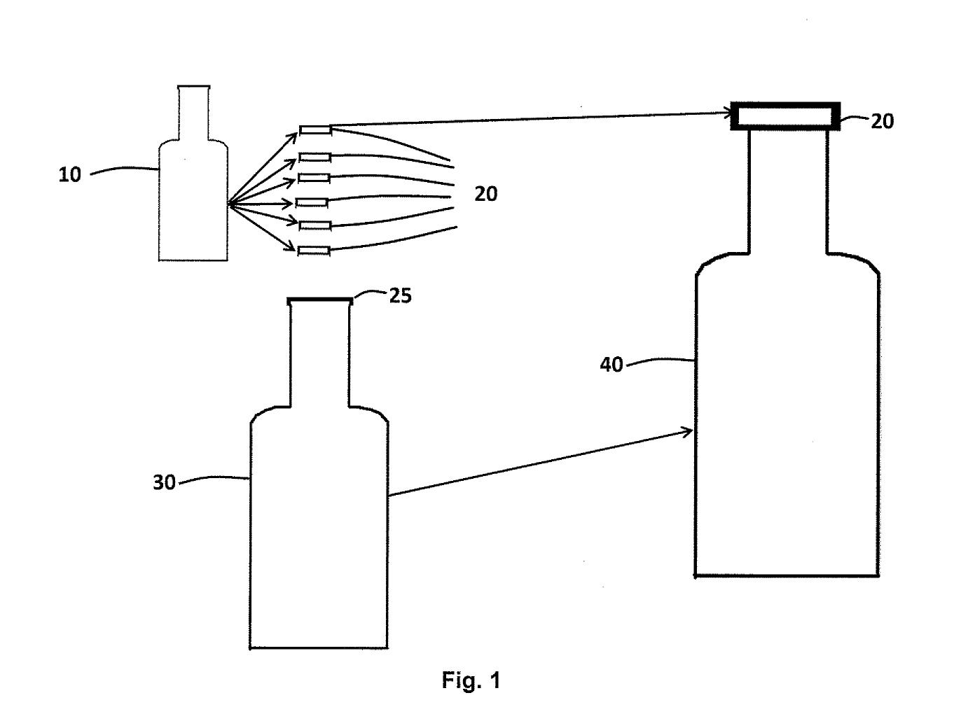

Manufacturing of vibration medicine products is illustrated in FIG. 1. An original vibration medicine product 10 which includes an essence is obtained, and its content is packed within a plurality of packed doses. In the example of FIG. 1 the packed doses are dosing caps 20 of drink bottles. Exemplary original vibration medicine products are Bach flowers remedies, Australian Bush flowers, Alaskan Flower essences and Pacific essences. The original vibration medicine product may include water and alcohol at 20% to 85% alcohol rating, preferably at 25% to 60% alcohol rating.

The manufacturer gets servings of a mass produced first product 30 like bottle 30 of FIG. 1, and replaces its cap 25 by a dosed cap 20 to get a unit 40 of a second product which is sold as containing a vibration medicine, as elaborated below. An end user purchases a second product unit 40, blends the contents of the dosed cap 20 into the attached serving and consumes it.

In some embodiments, first product 30 is a bottled water unit or a soft drink.

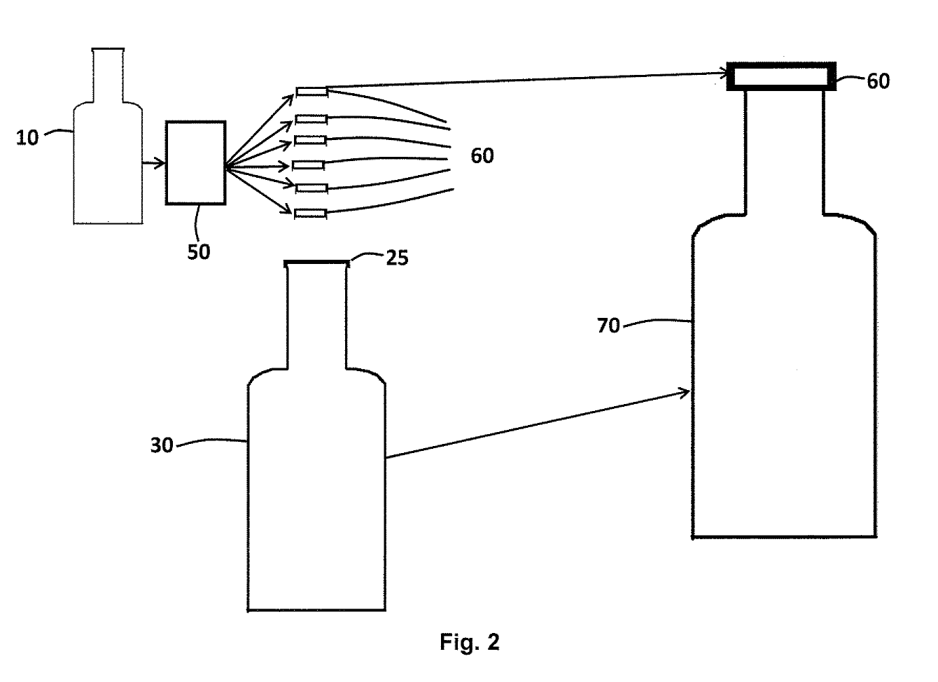

Another manufacturing embodiment is illustrated in FIG. 2. The physical shape of original vibration medicine product 10 is changed such that a vibration medicine product 50 having a different physical shape is obtained. In one example, the first physical shape is a liquid and the different physical shape is a powder. The contents of product 50 is divided to a plurality of dosed caps 60. A cap 60 replaces an original cap 25 serving of a first product 30 to get a unit 70 of a second product which is sold as containing vibration medicine.

The change of physical shape may be achieved by one of several exemplary processes. A first example is spraying several drops of vibration medicine product 10 on sucrose globules while mixing, allowing the mixture to dry and grinding the globules into a powder 50 of a desired particle size. A second exemplary process is spraying several drops of the vibration medicine product 10 on sugar crystals while mixing, allowing the mixture to dry, testing for dissolution, and if solubilty is poor, keeping on grinding up to getting particles 50 at a desired size. A third example is spraying several drops of the vibration medicine product 10 on icing sugar, while mixing, and allowing the mixture to dry and thus get dry material 50. To add flavour, vibration medicine 10 or 50 may be blended with a flavouring hyrosol before the step of spraying.

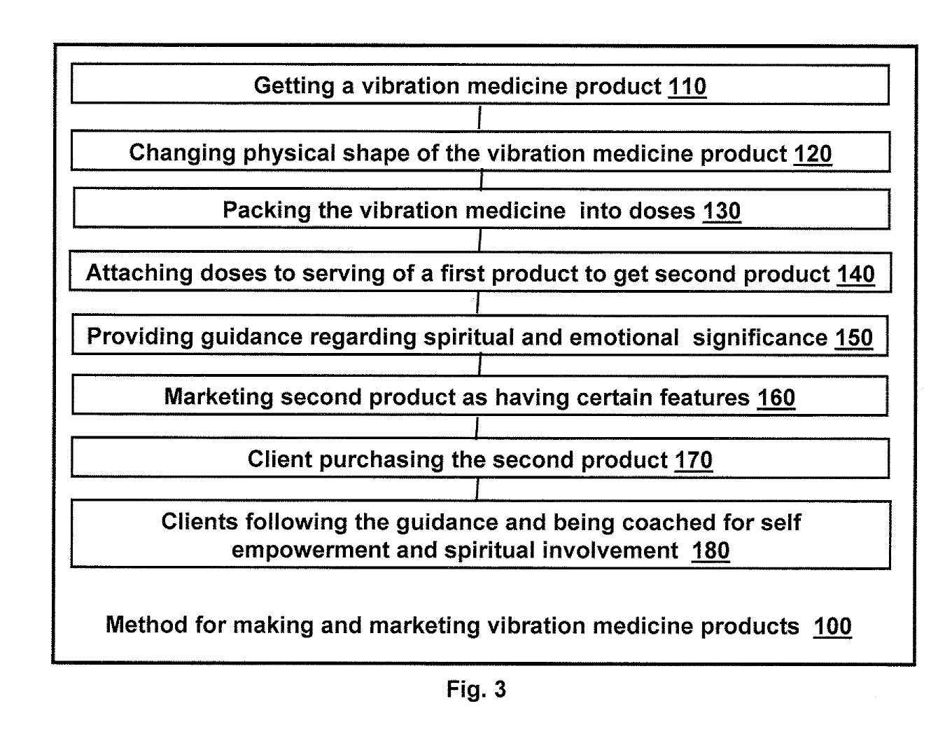

Selling and marketing the obtained second product 40 or 70 in the mass market is a challenging task. FIG. 3 is a flow chart of a method 100 for making and marketing vibration medicine products. Method 100 includes a step 110 of getting a vibration medicine product 10 which include an essence, a step 120 of changing physical shape of the original vibration medicine product 10 into a vibration medicine product 50, a step 130 of packing the original vibration medicine product 10 or the physically modified product 50 into packed doses 20 or 60, respectively, and a step 140 of attaching packed doses 20 or 60 to servings of a first product 30 to get units 40 or 70 of a second product for sale. Method 100 further includes a step 150 of providing means for delivering guidance regarding an holistic significance of using second products 40 or 70, and a step 160 of marketing second product 40 or 70 as including certain features. The features are being an improvement of the first product 30, being associated with the vibration medicine product 10, and using the second product being associated to the holistic significance.

In addition, method 100 includes a step 170 of clients purchasing the second product 40 or 70, and a step 180 of clients following the guidance, and thus being coached for self empowerment and spiritual evolvement.

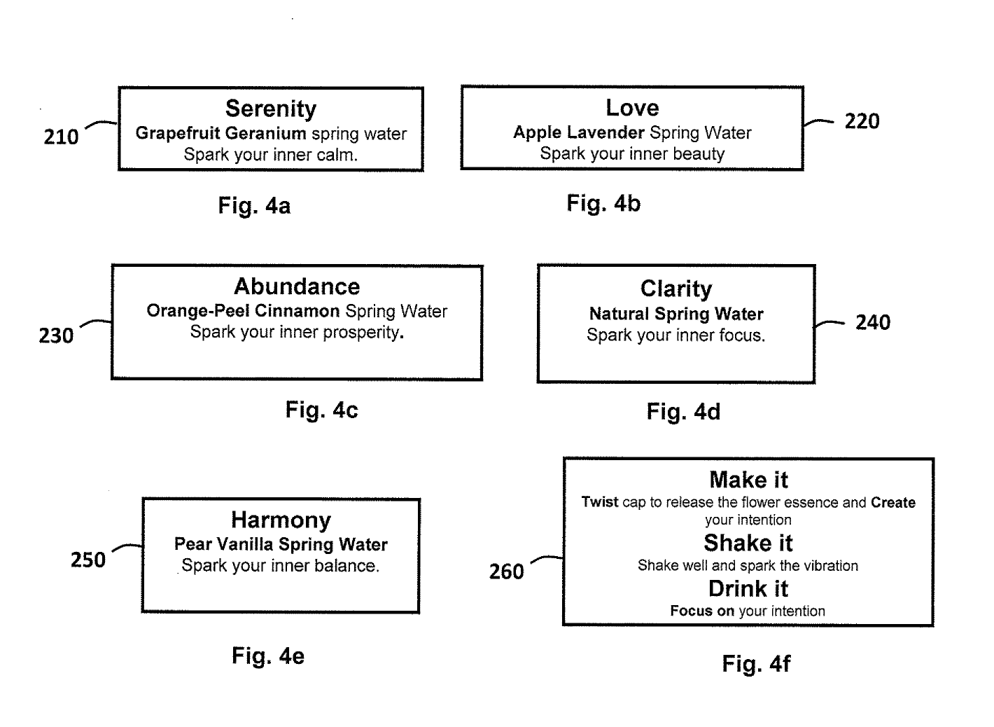

The guidance may be delivered in a variety of ways. First, a written guiding label may be affixed to a unit of second product 40. FIGS. 4a, 4b, 4c, 4d and 4e present typical labels 210, 220, 230, 240 and 250, for furnishing the clients a guidance for spiritual or emotional or physical significance associated with use of the second product. The guidance may be also for intentions and actions to be taken before, during, or after the use of the second product, as presented in label 260 of FIG. 4f. The intentions and actions are directed for self empowerment and spiritual evolvement of a user of second product 40.

In addition, an hidden label seen through a window may include text like “You can make it happen” or “I believe that natural vibrations can inspire people everywhere to transform and better their lives. I offer you this true gift with love” or “Conscious Water inspires awareness and inner change using a unique combination of pure spring water, flower essences, natural vibrations and your own heart's intention”

A second way to convey the guidance is by a label having an integrated barcode for initiating a visit in a website presenting the guidance. Similarly, a website address label directing to a website presenting the guidance may be affixed to second product 40 or 70. In such a website the guidance may be much more elaborated and convincing, as presented in the appendix.

In some embodiments, vibration medicine product 10 is a brand vibration medicine product, and second product 40 or 70 is licensed to have a label designating it with the same brand vibration medicine.

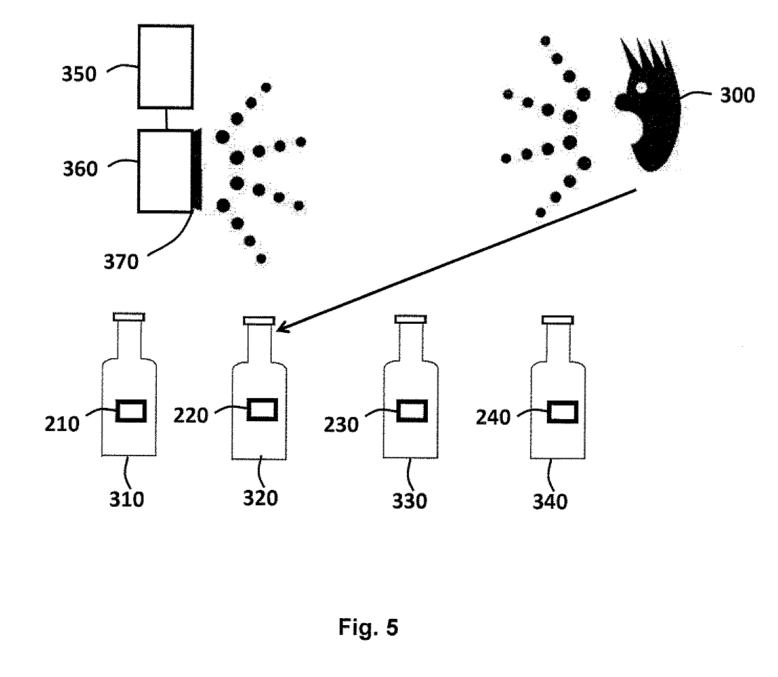

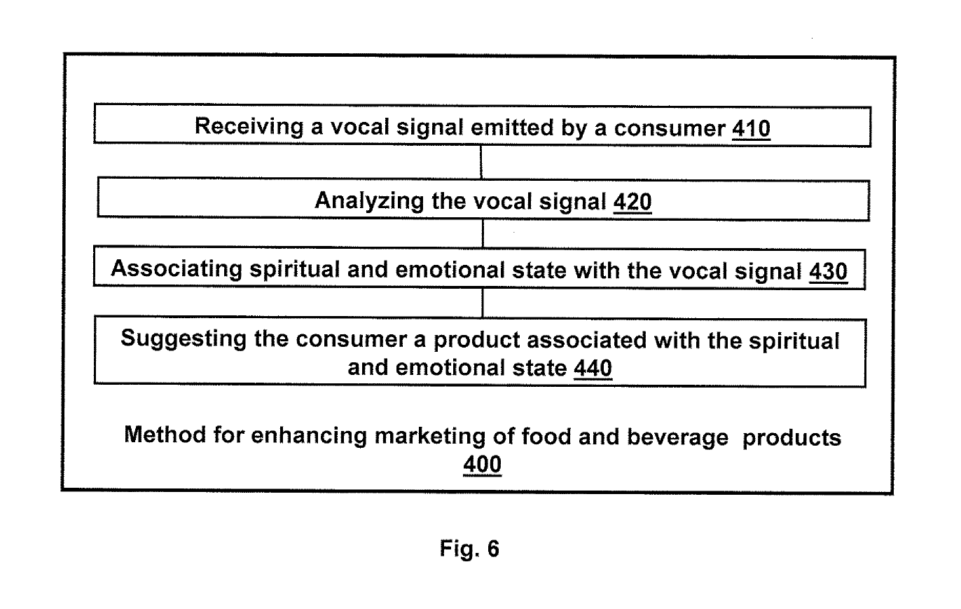

A method to enhance marketing of products of a certain food-and-beverage family of products is illustrated in FIGS. 5 and 6. In FIG. 5 a consumer 300 is considering buying one of several water bottles 310, 320, 330 and 340, for sale in a shop, whereas each bottle includes a vibration medicine essence and has a label associating the vibration medicine to a certain spiritual and emotional state. Bottles 310, 320, 330 and 340 have labels 210, 220, 230, and 240, respectively, on which the contents of FIGS. 4a-4d appear.

To help the consumer, the consumer is requested to speak to a microphone 350, which delivers the vocal signal to a voice analyzing module 360, like the module of http://exaudios.com/. Module 360 analyzes the signal intonation and associates the consumer with certain spiritual and emotional state. Consequently, a loudspeaker 370 or a display announces a bottle associated with the certain spiritual and emotional state and the consumer picks up the appropriate bottle. In the example of FIG. 5, Module 360 associated the consumer with “love” and consequently consumer picked up bottle 320 with a label designating love.

Referring now to FIG. 6, a method 400 for enhancing marketing of food and beverage products. Method 400 includes a step 410 of receiving a vocal signal associated with a consumer 300, a step 420 of analyzing the vocal signal, a step 430 of associating certain spiritual and emotional state with the vocal signal in accordance with results of the analysis, and a step 440 of suggesting consumer 300 to purchase a product 320 of a kind associated to the certain spiritual and emotional state.

The elements of FIG. 5 may be located apart from each other. For example, consumer 300 may be a sitting on a chair at home, using a laptop computer or a smartphone for preparing an internet shooping list. Approaching a list of bottled water products, consumer 300 is requested to speak to the laptop microphone 350 such as to record a sample vocal signal reflecting spritual and emotional state. Consequently, the recorded vocal signal is analysed by a remote vocal analyzing module and the results are conveyed to consuner 300 as a reccomendation on an appropriate bottled water 320.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A method for making and marketing vibration medicine products, the method including:
(a) getting a vibration medicine product comprising at least one essence;
(b) packing said vibration medicine product into a plurality of packed doses;
(c) attaching the packed doses to servings of a first product to get units of a second product for sale;
(d) providing means for delivering guidance regarding an holistic significance of using said second product; and
(e) marketing said second product as including at least the features of:
(i) being an improvement of said first product;
(ii) being associated with said vibration medicine product; and
(iii) using said second product being associated to said holistic significance,
wherein an end user purchasing a second product unit blends a packed dose into the attached serving.

2. The method of claim 1 wherein the method further includes the step of changing the physical shape of the vibration medicine product to a different physical shape before packing into said plurality of packed doses.

3. The method of claim 2 wherein the first physical shape is a liquid and the different physical shape is a dry material.

4. The method of claim 3 wherein the physical shape of the vibration medicine product is changed by at least one process of the group of processes consisting of:
(A) spraying several drops of the vibration medicine product on sucrose globules while mixing, allowing the mixture to dry and grinding the globules into a powder of a desired particle size;
(B) spraying several drops of the vibration medicine product on sugar crystals while mixing, allowing the mixture to dry, testing for dissolution, and if solubilty is poor, keeping on grinding up to getting particles at a desired size; and
(C) spraying several drops of the vibration medicine product on icing sugar, while mixing, and allowing the mixture to dry.

5. The method of claim 4 wherein the vibration medicine is blended with flavouring additives before the step of spraying.

6. The method of claim 1 wherein said means for delivering guidance of using said second product is selected from the group of means consisting of:
(A) a written guiding label for affixing to a unit of said second product;
(B) a label having an integrated barcode for initiating a visit in a website presenting said guidance; and
(C) a website address label directing to a website presenting said guidance.

7. The method of claim 1 wherein said guidance is for spiritual or emotional or physical significance associated with use of the second product.

8. The method of claim 1 wherein said guidance is for intentions and actions to be taken before, during, or after the use of the second product, the intentions and actions are directed for self empowerment and spiritual evolvement of a user of said second product.

9. The method of claim 6 wherein the method includes the steps of:
(f) clients purchasing the second product; and
(g) clients following said guidance and thus being coached for self empowerment and spiritual evolvement.

10. The method of claim 1 wherein said vibration medicine product includes water and alcohol at 20% to 85% alcohol rating.

11. The method of claim 1 wherein said vibration medicine product is selected from the group consisting of Bach flowers remedies, Australian Bush flowers, Alaskan Flower essences and Pacific essences.

12. The method of claim 1 wherein the packed doses are dosing caps of drink bottles.

13. The method of claim 1 wherein said vibration medicine product is a brand vibration medicine product and the second product is licensed to be associated with the same brand vibration medicine.

14. The method of claim 1 wherein said first product is selected from a group of products consisting of:
(A) bottled water;
(B) a soft drink;
(D) a chewing gum;
(E) a shampoo;
(F) a soap;
(G) a personal care product; and
(H) a food and beverage product.

15. A method to enhance marketing of products of a certain family of products, the products being of two or more kinds respectively associated with two or more holistic states, the method comprising:
(a) receiving a vocal signal associated with a consumer;
(b) analyzing said vocal signal;
(c) associating certain holistic state with said vocal signal in accordance with results of said analyzing; and
(d) suggesting said consumer to purchase a product of a kind associated to said certain holistic state.

16. The method of claim 15 wherein the family of products is selected from the group of product families consisting of food-and-beverage products, personal care products, personal development products, holistic products, and vibration medicine products.

17. The method of claim 15 wherein the method enhances marketing of bottled water units associated with several kinds of vibration medicine.

18. The method of claim 15 wherein the method is executed in a shop site equipped with a voice analyzing module adapted for analyzing intonation of a vocal signal and associating a source of said vocal signal with spiritual and emotional state.
